(19) United States
(12) Patent Application Publication
(10) Pub. No.: US 2008/0094468 A1
(43) Pub. Date: Apr. 24, 2008

(54) Method for displaying stereoscopic image and display system thereof

(75) Inventors: Yao-Shun Tseng, Nantou Shien (TW); Hsu-Hung Chen, Taipei Shien (TW); Hsin-Hung Lee, Kaohsiung Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/822,225

(22) Filed: Jul. 3, 2007

(30) Foreign Application Priority Data
Oct. 20, 2006 (TW) 095138909

(51) Int. Cl. H04N 13/00

(52) U.S. Cl. 348/43; 348/E13.003

(57) ABSTRACT

The invention discloses a method and system thereof for displaying a stereoscopic image including left-eye image data and right-eye image data. The invention utilizes persistence of vision to process the stereoscopic image based on display frequency, such that different images can be displayed at different time but on the same line of a screen. Accordingly, when the stereoscopic image is being displayed, the vertical resolution can be enhanced, and discontinuity of frames can be eliminated.

### BACKGROUND OF THE INVENTION

1. Field of the Invention

The invention relates to a method for displaying stereoscopic images and, more particularly, to a method for enhancing vertical resolution of a stereoscopic image and eliminating discontinuity of frames outputted by a display system.

2. Description of the Prior Art

In general, 3D stereoscopic image is formed by combining two sets of image data in different visual angles, wherein one set of image data corresponds to left-eye visual angle, and the other set of image data corresponds to right-eye visual angle. When 3D stereoscopic image is displayed, the left eye of a viewer merely sees the image data corresponding to left-eye visual angle, and the right eye of the viewer merely sees the image data corresponding to right-eye visual angle. Accordingly, a stereoscopic vision is generated in the brain of the viewer.

Referring to FIG. 1, FIG. 1 is a schematic diagram illustrating a 3D polarized screen 1 of the prior art. As shown in FIG. 1, pixels of the 3D polarized screen 1 is usually divided into a plurality of odd lines and even lines in order to display different polarized images for left eye and right eye, wherein the odd lines and even lines correspond to the left eye and right eye respectively.

Referring to FIG. 2, FIG. 2 is a schematic diagram illustrating a normal image and a polarized single-eye image. Because an image outputted by the 3D polarized screen 1 is formed by interlacing left-eye data and right-eye data, vertical resolution of the image is only half of that of the screen. Meanwhile, because an image seen by a single eye is a cross-line image, the image is usually incomplete or discontinuous. Accordingly, the image quality will be affected.

Therefore, the scope of the invention is to provide a method for displaying stereoscopic images in a display system to enhance the vertical resolution of the stereoscopic image and to eliminate discontinuity of frames. Accordingly, the method can solve the aforesaid problems.

### SUMMARY OF THE INVENTION

A scope of the invention is to provide a method for displaying stereoscopic images. The method utilizes persistence of vision to process stereoscopic images based on display frequency, such that different images can be displayed at different time but on the same line of a screen. Accordingly, the vertical resolution of the stereoscopic image is enhanced, and discontinuity of frames is eliminated.

According to a preferred embodiment, the method disclosed by the invention is used for displaying stereoscopic images, wherein the stereoscopic image comprises a left-eye image data and a right-eye image data. The method comprises the following steps.

In the beginning, a stereoscopic image is received. Afterward, an interlaced first image frame is generated according to the 2N-th line data of the left-eye image data and 2N-th line data of the right-eye image data, and an interlaced second image frame is generated according to the (2N−1)th line data of the left-eye image data and the (2N−1)th line data of the right-eye image data, wherein N is a natural number. Finally, the interlaced first image frame and the interlaced second image frame are displayed in sequence, or the interlaced second image frame and the interlaced first image frame are displayed in sequence, so as to display the stereoscopic image. Accordingly, different images can be displayed at different time but on the same line of a screen, such that the vertical resolution of the stereoscopic image is enhanced, and discontinuity of the frames is eliminated.

The advantage and spirit of the invention may be understood by the following recitations together with the appended drawing.

### BRIEF DESCRIPTION OF THE APPENDED DRAWINGS

FIG. 1 is a schematic diagram illustrating a 3D polarized screen of the prior art.

FIG. 2 is a schematic diagram illustrating a normal image and a polarized single-eye image.

FIG. 3 is a functional block diagram illustrating a display system according to a preferred embodiment of the invention.

FIG. 4 is a schematic diagram illustrating a stereoscopic image shown in FIG. 3.

FIG. 5 is a schematic diagram illustrating the left-eye image data and the right-eye image data shown in FIG. 4 being divided and combined.

FIG. 6 is a functional block diagram illustrating a display system according to another preferred embodiment of the invention.

FIG. 7 is a flow chart showing a method for displaying a stereoscopic image according to a preferred embodiment of the invention.

FIG. 8 is a flow chart illustrating step S102 shown in FIG. 7 in detail.

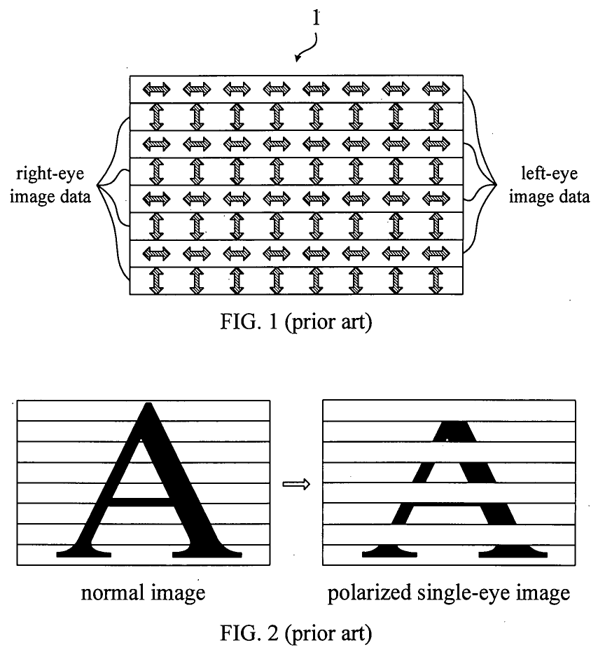

### DETAILED DESCRIPTION OF THE INVENTION

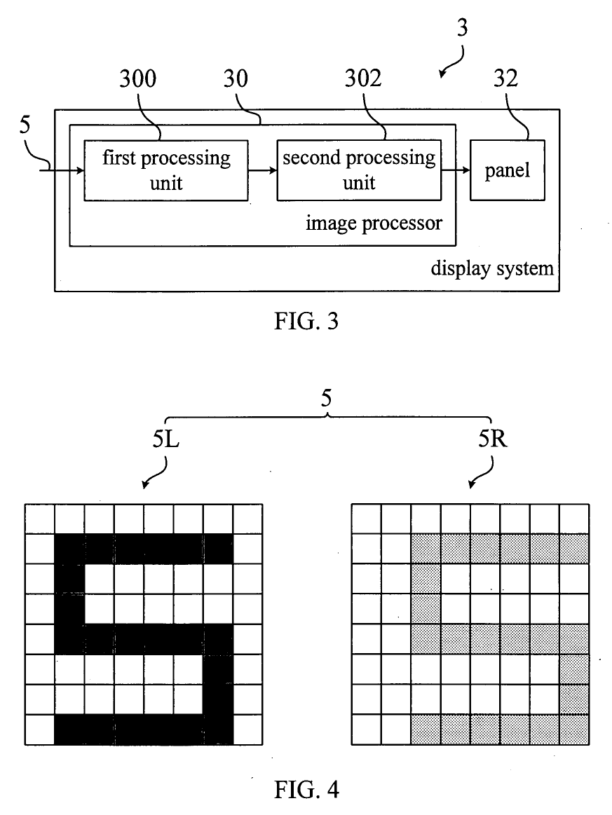

Referring to FIG. 3 and FIG. 4, FIG. 3 is a functional block diagram illustrating a display system 3 according to a preferred embodiment of the invention. FIG. 4 is a schematic diagram illustrating the stereoscopic image 5 shown in FIG. 3. As shown in FIG. 3, the display system 3 comprises an image processor 30 and a panel 32. The image processor 30 is used to receive the stereoscopic image 5, and the panel 32 is coupled to the image process 30. As shown in FIG. 4, the stereoscopic image 5 comprises a left-eye image data 5L and a right-eye image data 5R. In this embodiment, the image processor 30 receives the left-eye image data 5L and the right-eye image data 5R simultaneously.

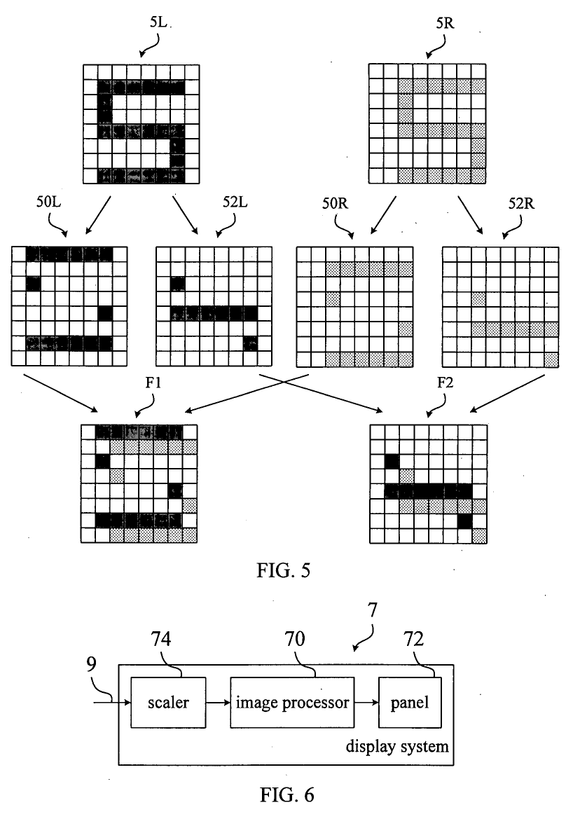

In this embodiment, the image processor 30 comprises a first processing unit 300 and a second processing unit 302. Referring to FIG. 5, FIG. 5 is a schematic diagram illustrating the left-eye image data 5L and the right-eye image data 5R shown in FIG. 4 being divided and combined. The first processing unit 300 is used to generate a first left-eye frame 50L by displaying the 2N-th line data of the left-eye image data 5L on the (2N−1)th line of a frame, and it also generates a second left-eye frame 52L by displaying the (2N−1)th line data of the left-eye image data 5L on the (2N−1)th line of a frame. Furthermore, the first processing unit 300 is used to generate a first right-eye frame 50R by displaying the 2N-th line data of the right-eye image data 5R on the 2N-th line of a frame, and it also generates a second right-eye frame 52R by displaying the (2N−1)th line data of the right-eye image data 5R on the 2N-th line of a frame. Afterward, the second processing unit 302 is used to combine the first left-eye frame 50L with the first right-eye frame 50R to generate an interlaced first image frame F1, and it also combines the second left-eye frame 52L with the second right-eye frame 52R to generate an interlaced second image frame F2.

Finally, the panel 32 displays the interlaced first image frame F1 and the interlaced second image frame F2 in sequence or displays the interlaced second image frame F2 and the interlaced first image frame F1 in sequence, so as to display the stereoscopic image 5 for the user. Accordingly, different images can be displayed at different time but on the same line of the panel 32, such that vertical resolution of the stereoscopic image 5 is enhanced, and discontinuity of the frames is eliminated.

Referring to FIG. 6, FIG. 6 is a functional block diagram illustrating a display system 7 according to another preferred embodiment of the invention. The main difference between the display system 7 and the display system 3 is that the display system 7 further comprises a scaler 74 being coupled to an image processor 70. When a stereoscopic image 9 inputted into the display system 7 complies with a side-by-side format, an above-and-below format, or a page-flipping format, the stereoscopic image 9 will be scaled first by the scaler 74 to comply with a native resolution of a panel 72. The functions of the display system 7 shown in FIG. 6 are substantially the same with that of the display system 3 shown in FIG. 3, so the functions of the display system 7 will not be described in detail here again.

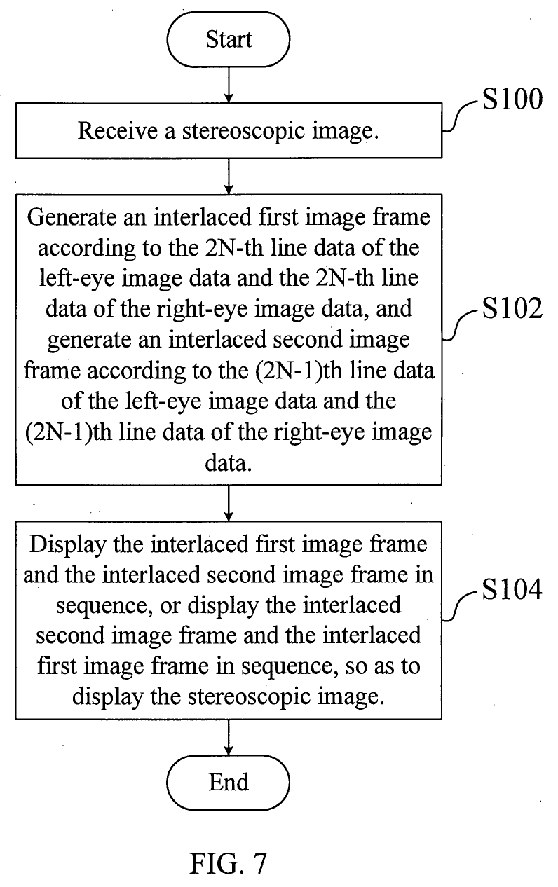

Referring to FIG. 7, FIG. 7 is a flow chart showing a method for displaying a stereoscopic image according to a preferred embodiment of the invention. The method disclosed by the invention is used for displaying a stereoscopic image comprising a left-eye image data and a right-eye image data. In the beginning, step S100 is performed to receive the stereoscopic image. Afterward, step S102 is performed to generate an interlaced first image frame according to the 2N-th line data of the left-eye image data and the 2N-th line data of the right-eye image data and to generate an interlaced second image frame according to the (2N−1)th line data of the left-eye image data and the (2N−1)th line data of the right-eye image data. Finally, step S104 is performed to display the interlaced first image frame and the interlaced second image frame in sequence or to display the interlaced second image frame and the interlaced first image frame in sequence, so as to display the stereoscopic image for the user.

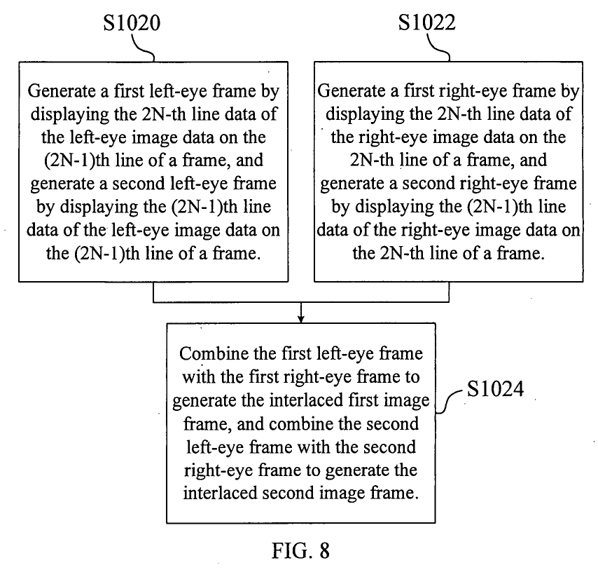

Referring to FIG. 8, FIG. 8 is a flow chart illustrating step S102 shown in FIG. 7 in detail. Step S1020 is performed to generate a first left-eye frame by displaying the 2N-th line data of the left-eye image data on the (2N−1)th line of a frame, and to generate a second left-eye frame by displaying the (2N−1)th line data of the left-eye image data on the (2N−1)th line of a frame. Then, step S1022 is performed to generate a first right-eye frame by displaying the 2N-th line data of the right-eye image data on the 2N-th line of a frame, and to generate a second right-eye frame by displaying the (2N−1)th line data of the right-eye image data on the 2N-th line of a frame. Finally, Step S1024 is performed to combine the first left-eye frame with the first right-eye frame to generate the interlaced first image frame and to combine the second left-eye frame with the second right-eye frame to generate the interlaced second image frame.

In this embodiment, the left-eye image data and the right-eye image data of the stereoscopic image are received simultaneously.

In another preferred embodiment, if the stereoscopic image complies with the side-by-side format, the above-and-below format, or the page-flipping format, the stereoscopic image needs to be scaled to comply with the native-resolution of the panel.

Compared to the prior art, the invention utilizes persistence of vision to process a stereoscopic image based on display frequency, such that different images can be displayed at different time but on the same line of a screen. Accordingly, the vertical resolution of the stereoscopic image can be enhanced, and discontinuity of frames can be eliminated.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for displaying a stereoscopic image, the stereoscopic image comprising a left-eye image data and a right-eye image data, the method comprising steps of:
(a) receiving the stereoscopic image;
(b) generating an interlaced first image frame according to the 2N-th line data of the left-eye image data and the 2N-th line data of the right-eye image data, and generating an interlaced second image frame according to the (2N−1)th line data of the left-eye image data and the (2N−1)th line data of the right-eye image data, wherein N is a natural number; and
(c) displaying the interlaced first image frame and the interlaced second image frame in sequence, or displaying the interlaced second image frame and the interlaced first image frame in sequence, so as to display the stereoscopic image.

2. The method of claim 1, wherein the step (b) comprises steps of:
(b1) generating a first left-eye frame by displaying the 2N-th line data of the left-eye image data on the (2N−1)th line of a frame, and generating a second left-eye frame by displaying the (2N−1)th line data of the left-eye image data on the (2N−1)th line of a frame;
(b2) generating a first right-eye frame by displaying the 2N-th line data of the right-eye image data on the 2N-th line of a frame, and generating a second right-eye frame by displaying the (2N−1)th line data of the right-eye image data on the 2N-th line of a frame; and
(b3) combining the first left-eye frame with the first right-eye frame to generate the interlaced first image frame, and combining the second left-eye frame with the second right-eye frame to generate the interlaced second image frame.

3. The method of claim 1, wherein the left-eye image data and the right-eye image data of the stereoscopic image are received simultaneously.

4. The method of claim 1, wherein the stereoscopic image complies with a side-by-side format, an above-and-below format, or a page-flipping format.

5. The method of claim 4, further comprising step of:
scaling the stereoscopic image before performing the step (a).

6. A display system for displaying a stereoscopic image, the stereoscopic image comprising a left-eye image data and a right-eye image data, the display system comprising:
an image processor for receiving the stereoscopic image, generating an interlaced first image frame according to the 2N-th line data of the left-eye image data and the 2N-th line data of the right-eye image data, and generating an interlaced second image frame according to the (2N−1)th line data of the left-eye image data and the (2N−1)th line data of the right-eye image data, wherein N is a natural number; and
a panel, coupled to the image processor, for displaying the interlaced first image frame and the interlaced second image frame in sequence, or displaying the interlaced second image frame and the interlaced first image frame in sequence, so as to display the stereoscopic image.

7. The display system of claim 6, wherein the image processor comprises:
a first processing unit for generating a first left-eye frame by displaying the 2N-th line data of the left-eye image data on the (2N−1)th line of a frame, generating a second left-eye frame by displaying the (2N−1)th line data of the left-eye image data on the (2N−1)th line of a frame, generating a first right-eye frame by displaying the 2N-th line data of the right-eye image data on the 2N-th line of a frame, and generating a second right-eye frame by displaying the (2N−1)th line data of the right-eye image data on the 2N-th line of a frame; and
a second processing unit for combining the first left-eye frame with the first right-eye frame to generate the interlaced first image frame, and combining the second left-eye frame with the second right-eye frame to generate the interlaced second image frame.

8. The display system of claim 6, wherein the image processor receives the left-eye image data and the right-eye image data of the stereoscopic image simultaneously.

9. The display system of claim 6, wherein the stereoscopic image complies with a side-by-side format, an above-and-below format, or a page-flipping format.

10. The display system of claim 9, further comprising a scaler coupled to the image processor for scaling the stereoscopic image to comply with a native resolution of the panel.
